(19) United States
(12) Patent Application Publication
(10) Pub. No.: US 2015/0236575 A1
(43) Pub. Date: Aug. 20, 2015

(54) MAGNETIC SHIELD FOR HYBRID MOTORS

(71) Applicant: Raymond James Walsh, Dallas, TX (US)

(72) Inventor: Raymond James Walsh, Dallas, TX (US)

(21) Appl. No.: 14/625,561

(22) Filed: Feb. 18, 2015

Related U.S. Application Data
(60) Provisional application No. 61/941,000, filed on Feb. 18, 2014.

(51) Int. Cl. H02K 21/46; H02K 16/02; H02K 1/27; H02K 21/12

(52) U.S. Cl. CPC H02K 21/46; H02K 21/12; H02K 16/02; H02K 1/278

(57) ABSTRACT

A magnetic flux shield is described for employment within a hybrid permanent magnet/induction motor, allowing for both synchronous and asynchronous operation. A hybrid rotor comprises coaxially nested Halbach cylinders each with an attached induction rotor and a magnetic flux shield. This hybrid rotor rotates about an armature residing in the space between the induction rotors. The armature comprises independent field winding circuits that may be configured by a controller for either polyphase asynchronous or synchronous operation. At start up or where high torque is required, multiphase current urges rotation of the induction rotor. At a predetermined operational speed a magnetic flux shield releases and allows synchronous operation for greater energy efficiency.

### CROSS-REFERENCE TO RELATED APPLICATIONS

This application claims the benefit of U.S. Provisional Application No. 61/941,000 filed Feb. 18, 2014, all of which is hereby incorporated herein by reference, in their entirety.

### TECHNICAL FIELD

The invention relates generally to electric motors and generators and, more particularly, to electric motors and generators using a hybrid synchronous/asynchronous design.

### BACKGROUND

The Energy Independence and Security Act went into effect in the U.S. in 2010, mandating higher efficiency standards for three-phase ac industrial motors. With motors operating in the 90%-plus efficiency range for most ratings, however, there isn't much more room for improvement. Laws of physics make it prohibitive to design ac-induction motors with higher efficiencies. The reason for this inherent inefficiency has to do with slip. Induction, or asynchronous, motors develop torque because of a slip between the speed of the rotor and the speed of the magnetic flux rotating around the stator winding. Thus, there is always an energy loss associated with slip that reduces induction-motor efficiency.

In contrast to asynchronous motors, permanent magnet synchronous motors have no such slip loss. Unlike induction motors, which induce a secondary magnetic field in the rotor, PM motors use high-performance neodymium rotor magnets to create a magnetic field that is always present. PM-rotor technology is therefore more efficient than induction technology.

“A motor that is three to four efficiency bands higher than today's Premium Efficient (induction) motors will likely be a hybrid design,” says Richard Schaefer, senior variable-speed product marketing manager, Baldor Electric Co., Fort Smith, Ark., in an article appearing in Machine Design authored by Frances Richards. “It will incorporate both an induction cage for starting and permanent magnets for high-efficiency operation and running at true synchronous speed. This future hybrid may be a squirrel-cage induction or synchronous reluctance design enhanced with permanent-magnet technology. This motor design could ultimately replace today's induction motors.”

The magnetic field poles of a permanent magnet motor commonly lie on a surface. The relative motion of a current-carrying wire, or field winding, over this surface generates an electromotive force. The efficiency of the motor depends in part on the gap, or distance between the magnetic field pole and the current-carrying wire. A more efficient design incorporates a rotor passing through high flux, three-dimensional magnetic field poles in the space between a pair of coupled coaxial Halbach cylinders. In other words, rather than a wire passing over the top of a magnet, the wire passes through the space between two coupled magnets. Such a dual-rotor design is efficient and also eliminate the need for a small gap.

A Halbach series of permanent magnets arranged as two coaxially nested Halbach cylinders provides high magnetic flux between the cylinders in the form of alternating field poles. Such coaxially-nested cylinders are described in Wikipedia as follows: “a magnetized cylinder composed of ferromagnetic material producing (in the idealized case) an intense magnetic field confined entirely within the cylinder with zero field outside” is magnetically coupled to a second Halbach cylinder “magnetized such that the magnetic field is entirely outside the cylinder, with zero field inside.” The magnetic flux of the outer Halbach cylinder is directed inward, and the magnetic flux of the inner cylinder is directed outward, magnetically coupling the cylinders. This produces intense magnetic fields between the nested cylinders, but the field is not uniform. There are nodes or poles of intense magnetic flux density distributed symmetrically between the cylinders, and neighboring nodes alternate in polarity from magnetic north directed radially outward to magnetic north directed radially inward. These magnetic poles magnetically couple the two cylinders so that as one cylinder rotates the torque is transferred to the other. But these magnetic nodes may also serve as alternating field poles within a permanent magnet motor. And the cylindrical shape lends itself well to a hybrid design incorporating a cylindrical squirrel cage induction rotor.

A review of the prior art could find no examples of motors or generators employing a hybrid squirrel cage-type rotor that would enable the motor to operate in asynchronous mode at startup or when high torque is required, and synchronous mode once at operational speed for greater energy efficiency.

### SUMMARY

Dual permanent magnet rotors are magnetically coupled to one another, and configured in coaxial, cylindrical Halbach series. The magnetic flux of each Halbach cylinder is directed predominantly towards the space between the cylinders. Magnetic coupling between the Halbach cylinders occurs at discreet nodes of magnetic flux between the radially oriented magnets of each cylinder. These nodes alternate in magnetic polarity, and serve in this embodiment as magnetic field poles during synchronous operation.

For asynchronous operation, a squirrel cage rotor is located adjacent to each Halbach cylinder. This rotor incorporates a releasable magnetic flux shield for shielding the induction rotor during asynchronous operation. A stator resides in the space adjacent to the Halbach magnet array, and is made of independent field winding circuits that may be combined or configured for either three-phase operation or single-phase operation. At motor startup, where high torque is required, multi-phase power is supplied to the field windings and the motor functions like an induction or asynchronous motor. In this mode, a motor controller supplies multi-phase alternating current to the armature field windings so as to produce a rotating magnetic field. This rotating magnetic field induces a secondary magnetic field in both the inner and outer squirrel cage rotors, resulting in rotation of the hybrid rotor assembly.

As the hybrid rotor assembly approaches synchronous speed, the magnetic flux shield is released allowing flux from the permanent magnets to interact with the stator in typical synchronous fashion. There are many possible mechanisms for releasing the flux shield, such as a small servo motor. Whatever the means, when the magnetic flux shield is engaged, the motor may operate as a typical induction motor. When the magnetic flux shield is released, the motor may operate as a typical synchronous permanent magnet motor. I envision a centrifugal release mechanism attached to the magnetic flux shield made of a series of flux bridges. These flux bridges are made of iron, silicon steel, or other ferromagnetic materials. At startup or low RPM's, each flux bridge causes a short-circuit of the magnetic circuit between adjacent field poles on the magnet array, thus effectively shielding the induction or squirrel cage rotor. At higher RPM's, the centrifugal release mechanism activates and slides or rotates the magnetic flux shield so that the flux bridges no longer short-circuit magnetic flux between adjacent field poles. When this happens, magnetic flux from the permanent magnets blocks the induced current in the squirrel cage rotor, and the motor ceases to operate in asynchronous mode. A controller may be envisioned which senses the momentary torque disruption, and immediately energizes the stator for synchronized operation. This is now possible because the permanent magnets are no longer shielded.

the motor controller transitions to synchronous single-phase operation for greater energy efficiency. In this mode, single-phase alternating current is supplied to the field windings such that adjacent windings now produce opposing magnetic fields. The magnetic polarity of these fields alternates just ahead of the magnetic field poles existing between the Halbach cylinders in order to maintain rotor rotation.

Transition from asynchronous to synchronous operation occurs at a predetermined RPM threshold as detected, for example, by a Hall effect sensor. The motor controller transitions from three-phase asynchronous operation to single-phase synchronous operation by electronic recombination of the independent field winding circuits. The frequency of the single-phase alternating current during transition is set by the motor controller to synchronize with the rotating permanent magnets within the hybrid rotor assembly in such a way adds to maintain a constant rotational rate during the transition from asynchronous to synchronous operation.

Power transfer between motor/generator windings is achieved, for example, by employment of slip rings, but these are subject to friction, wear, intermittent contact, and limitations on the rotational speed that can be accommodated without damage. Typical rotary transformers (in pairs) provide longer life than slip rings, however. Rotary transformers may be employed wherein the primary and secondary windings occupy separate halves of a cup core; these concentric halves face each other, with one half mounted to the rotor shaft the other half attached to the stator. Magnetic flux couples one half of the cup core to the other across an air gap, providing the mutual inductance that transfers energy brushlessly from the motor/generator windings. Multiphase power transfer may also be achieved using brushless synchros. These rotary transformers have a cylindrical air gap between windings, the primary attached to and rotating with the rotor, the secondary attached mechanically to the stator. The rotor winding is a spool-shaped with the winding placed like thread on a spool. The flanges are the pole pieces. The stator winding is a ferromagnetic cylinder with the winding inside, and end poles that are discs with holes, like washers. Slip rings, rotary transformers, and brushless synchros are well known to those familiar with the art.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

In order that the invention may be more clearly understood, it will now be disclosed in greater detail with reference to the accompanying drawings, wherein:

FIG. 1a is a cross-sectional schematic of the embodiment depicted with three-phase alternating current supplied to the coils.

FIG. 1b is a cross-sectional schematic of the embodiment depicted with single-phase alternating current supplied to the coils.

FIG. 2a is a schematic of an example of fringing between permanent magnets and stator windings.

FIG. 2b is a schematic of the enhancing effect of a flux diffuser on fringing between permanent magnets and stator windings.

FIG. 3a is a schematic demonstrating the shielding effect of the engaged magnetic flux shield during asynchronous motor operation.

FIG. 3b is a schematic demonstrating the released magnetic flux shield in a position allow exposure of the stator windings to magnet flux during synchronous motor operation.

FIG. 4 is a schematic of an embodiment of a magnetic shield release mechanism.

FIG. 5 demonstrates an embodiment of a motor or generator with a wave-wound stator with coaxial Halbach cylinder.

### DETAILED DESCRIPTION OF THE DRAWINGS

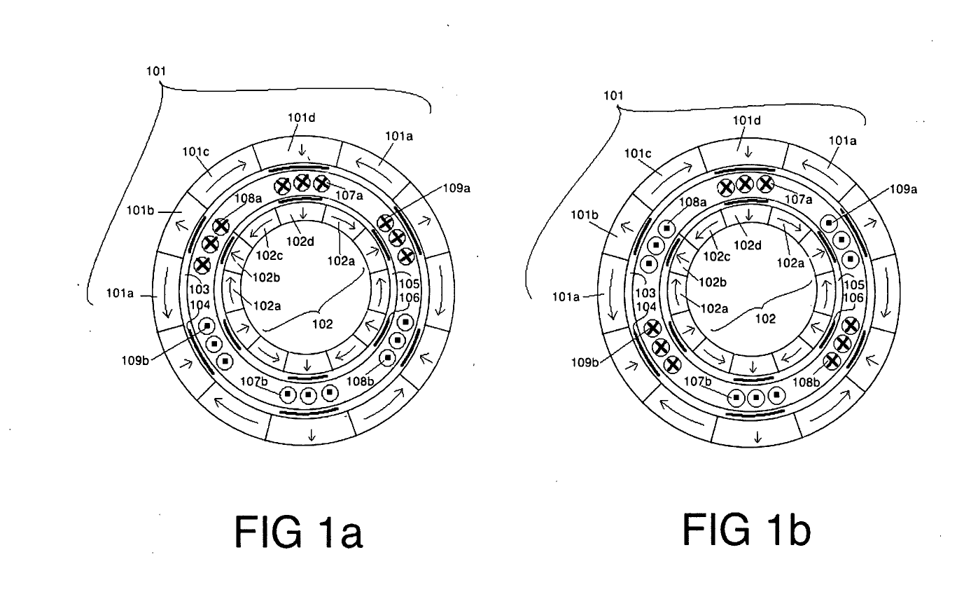

One embodiment of the motor is illustrated in cross-section in FIG. 1a (asynchronous mode) and FIG. 1b (synchronous mode). These two modes are structurally identical except for the configuration of the field windings 107, 108, and 109. FIG. 1a depicts three-phase operation in which the winding segments 107a, 108a, and 109a all have current flowing in the same direction (into the page as designated by the “x” in the circle), and the current in each is 120 degrees out of phase relative to the other two. In the return winding segments 107b, 108b, and 109b, the current in each is flowing in the same direction (out of the page as designated by the dot in the circle), and the current in each is likewise 120 degrees out of phase. FIG. 1a and FIG. 1b are otherwise identical depictions of this embodiment. Not shown is the motor controller that determines the operational mode, nor the sensor that detects motor speed.

In both FIG. 1a and FIG. 1b, a primary hybrid rotor assembly comprises the primary squirrel cage assembly 103 attached to primary field magnetic assembly 101. The primary field magnet assembly 101 comprises a cylindrical Halbach series of magnets, the arrows within each magnet designating magnetic north. As is typical of a Halbach series, adjacent magnets are rotated 90 degrees. Circumferentially oriented magnets 101a and 101 c are shown with magnetic north oriented counterclockwise and clockwise respectively. Radially oriented magnets 101b and 101d are shown with magnetic north oriented away from center and towards the center respectively. Embedded between the squirrel cage bars 103 are ferromagnetic elements 104 attached adjacent to each radially oriented magnet interior to primary field magnet assembly 101.

Magnetically coupled to the primary hybrid rotor assembly is an analogous secondary hybrid rotor assembly comprising a secondary magnetic assembly 102 attached to secondary squirrel cage assembly 105. Circumferentially oriented magnets are represented in examples 102a and 102c, shown with magnetic north oriented clockwise and counterclockwise respectively. Radially oriented magnets are represented in examples 102b and 102d, shown with magnetic north oriented away from center and towards the center respectively. Another Halbach array is represented by the five magnet series 102a, 102b, 102c, 102d, and a second 102a. Embedded between the bars of secondary squirrel cage 105 are ferromagnetic elements 106 located immediately adjacent to each radially-oriented magnet exterior to secondary field magnet assembly 102.

The radially-directed magnets of the primary and secondary field magnet assemblies align magnetically, for example 101b aligns or magnetically couples with 102b so that magnetic north points away from the center while 101d aligns or magnetically couples with 102d so that magnetic north directed towards the center.

The field windings 107, 108, 109 of the armature or stator may be either lap wound or wave wound, and occupy the space between the primary hybrid assembly 101 and the secondary hybrid assembly 102. The armature in this embodiment comprises field windings having three lengths of wire wherein current comes out of the page (107a, 108a, and 109a) and on the opposite side of the armature three corresponding lengths of wire wherein current enters the page (107b, 108b, and 109b). FIG. 1a and FIG. 1b follow the standard convention for electrical current flow wherein an “x” within a circle represents a wire with current flowing out of the page in one length of a winding, and dot within a circle represents a wire with current flowing into the page in the return length of field winding

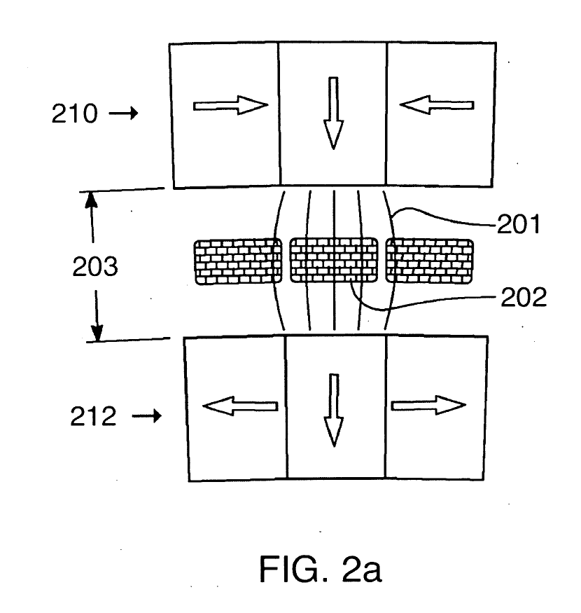

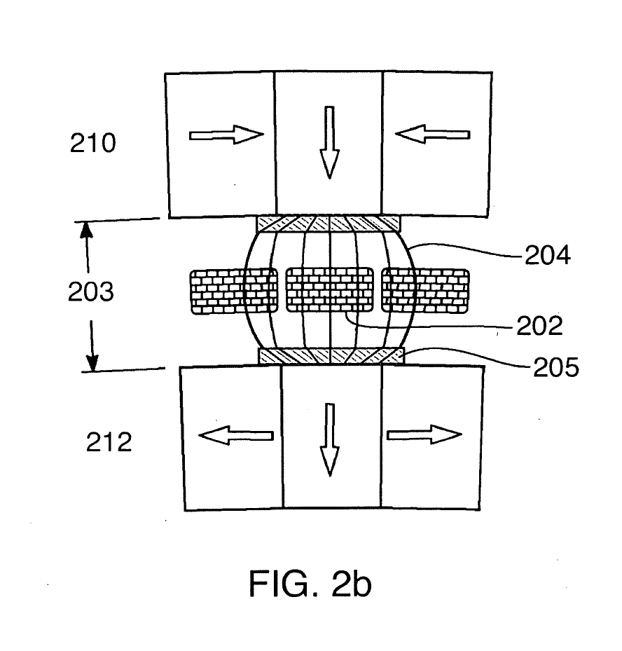

FIG. 2a and FIG. 2b are meant to be considered together. Both show two magnet arrays 210 and 212 separated by gap 203 through which rotates armature 202.

The fringing magnetic field lines 201 are enhanced by the placement of flux diffuser 205. The flux diffuser lies between the magnet array and the armature at a magnetic pole, and overlaps at lease one of the adjacent magnets. This overlap functions to spread out the magnetic field lines 204 thus reducing torque ripple.

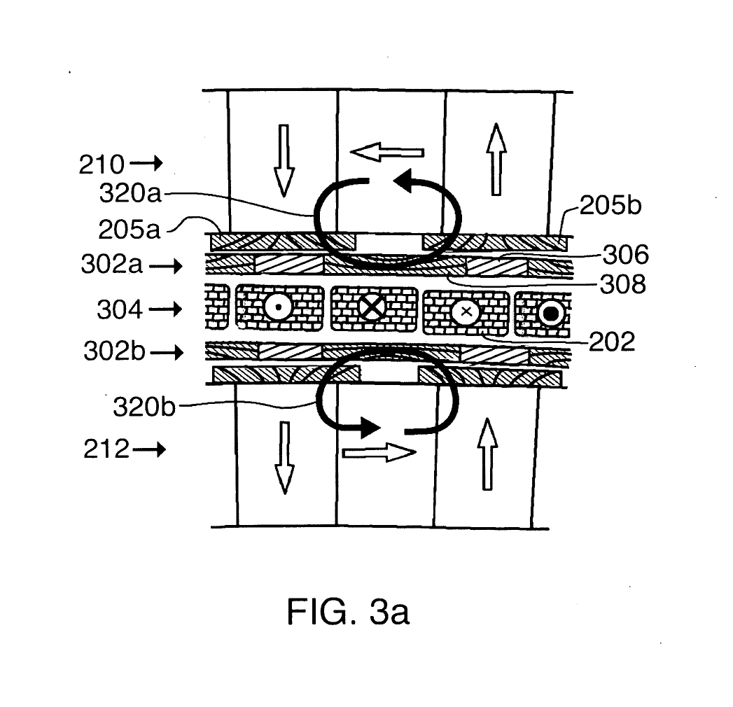

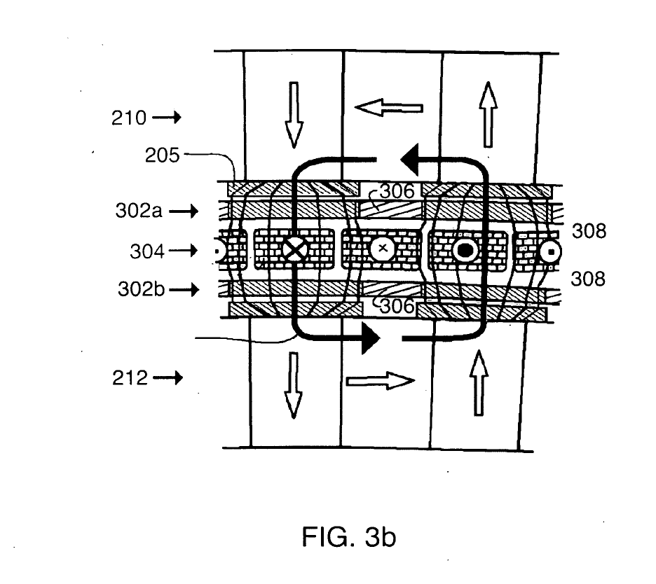

FIG. 3a shows the magnetic flux shield in the engaged position, effectively isolating the magnetic flux circuit 320a to magnet array 210. Magnetic flus flows from magnet array 210 into flux diffuser 205a, and then into flux bridge 308 before passing through flux diffuser 205b and back into magnet array 210 to complete the magnetic circuit. An analogous magnetic circuit is represented by 320b flowing through magnet array 212.

Magnetic flux bridge bridge 308 may be made of iron, silicon steel, or other ferromagnetic material. Induction rotor 306 is made of aluminum, copper, or other conducting material, and may be configured as a standard squirrel cage rotor. The induction rotor 306 and the magnetic flux bridge 308 together make up the hybrid rotor.

The magnetic flux produced by magnet arrays 210 and 212 is blocked from reaching stator 304, configured in this example for two phase operation. The circle with a large X and the circle with the large black dot represent opposite phases within the same circuit. The small x and the small black dot represent opposite phases within a second circuit. This configuration allows for asynchronous operation as the stator 304 may induce current within the squire cage 306 of hybrid rotor 302a. An analogous relationship exists between stator 304 and hybrid rotor 302b.

FIG. 3b is a schematic of the motor configured for synchronous operation. Magnetic flux shield 302a and 302b have been disengaged allow magnetic circuit 322 to flow between magnet arrays 210 and 212. Since both the magnetic diffuser 205 and the flux bridge 308 are made of ferromagnetic material, magnetic flux easily flows towards stator 304. The hybrid rotors 302a and 302b do not substantially effect motor function in this mode.

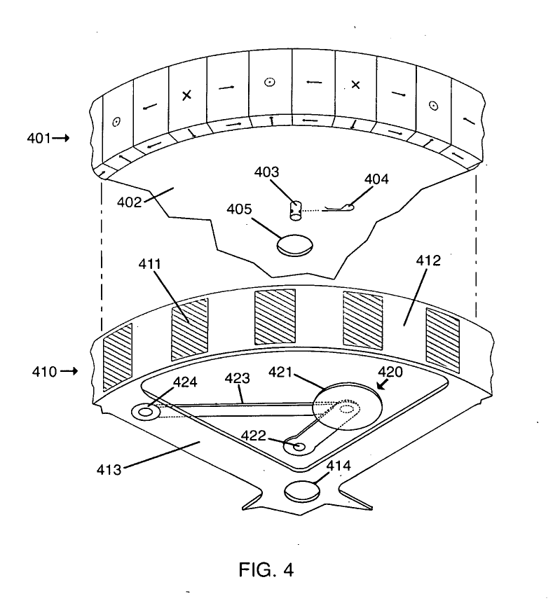

FIG. 4 demonstrates one preferred embodiment. Transition between asynchronous mode (shielded) and synchronous mode (unshielded) depends on the position of the magnetic flux shield 410 relative to magnet array 401. In this depiction, magnetic array 401 lies underneath magnetic flux shield 410, connected by centrifigal release mechanism 420. Magnet array 401 is supported by disk 402 attached at hole 405 to an axle (not shown). Pin 403 is attached to plate 402. This provides a pivot point for the centrifigal release mechanism 320 about hole 422. The centrifigal release mechanism 420 has a weight 421 attached to connecting rod 423. Connecting rod 423 is attached to magnetic flux shield frame 413 at pivot point 424. Magnetic flux shield frame 413 is attached at hole 414 to an axle (not shown).

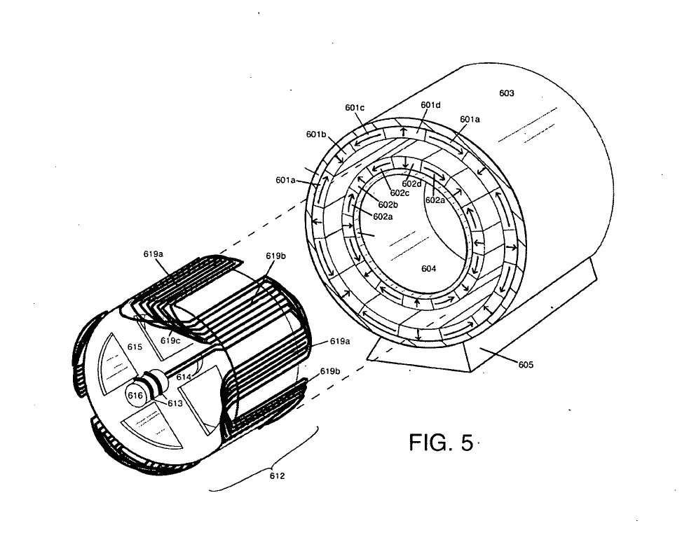

FIG. 5 is meant to impart a clearer understanding of an embodiment of the permanent magnet synchronous motor component of a hybrid motor embodiment. A perspective view of a pair of coaxially nested Halbach cylinders is shown in FIG. 5 wherein each cylinder is configured with a plurality of permanent magnets having arrows designating magnetic north. An example of a Halbach array in the inner cylinder is depicted by permanent magnets 602a, 602b, 602c, 602d, and 602a. The series continues in repeating fashion around the cylinder glued or otherwise attached to support cylinder 604. Again, each successive permanent magnet is oriented 90 degrees from its contiguous neighbor, and radially oriented magnets 602b and 602d alternate with circumferentially oriented magnets 602a and 602c. The configuration of Halbach series of magnets in the inner cylinder directs magnetic flux predominantly outward towards the outer cylinder. Likewise, the outer cylinder depicts an example of a Halbach array in the arrangement of permanent magnets 601a, 601b, 601c, 601d, and 601a. The Halbach series continues in repeating fashion around the cylinder attached to cylinder scaffolding 603. Each successive permanent magnet is oriented 90 degrees from its contiguous neighbor, and radially oriented magnets 601b and 601d alternate with circumferentially oriented magnets 601a and 601c. The configuration of Halbach series in the outer cylinder directs magnetic flux predominantly inward towards the inner cylinder.

The rotor assembly 612 comprises a support frame 615 around which is attached field winding 119. In this embodiment, a wave winding is depicted although it is well understood to those familiar with the art that a lap winding may also be employed to the same effect. For the purpose of illustrating the permanent magnet synchronous component of the hybrid motor, only one field winding is shown in this embodiment. The field winding section 619a comprises a bundle of short lengths of wire that run parallel to the axis of rotation of rotor 612. Current flowing through these wires flows in the same direction before proceeding through turn 619c where the windings are cooled by airflow as the rotor turns. Current through field winding section 619b flows in the opposite direction compared to current flowing through 619a. Wire leads 614 run inside shaft 616 and connects electrically to slip rings 613, which subsequently connect to the power source (not shown) and controller (not shown).

### Operation

FIG. 1a and FIG. 1b depict a schematic cross-sectional representation of the present embodiment with FIG. 1a showing three-phase operation while FIG. 1b shows single-phase operation. A lap wound or wave wound armature having field windings 107, 108, and 109 is mounted between zones of high magnetic flux between axially oriented magnets (101b and 102b, for example). This armature has typical three-phase alternating current passing through the windings, each 120 degrees out of phase relative to the other. This embodiment has three field windings 107, 108, and 109, but other embodiments may have any number of field windings. At start up or when high torque is required, the armature produces a rotating magnetic field that induces a secondary magnetic field in both the inner squirrel cage 105 and the outer squirrel cage 103. The induced magnetic field produces rotation of the rotor. In this mode, the motor is functioning as an asynchronous induction motor and the field magnet assemblies 101 and 102 are just along for the ride, not contributing to motor function. This mode is capable of high torque performance ideal for applications having variable load. Minimizing the gap between the dual squirrel cage rotors and the armature would maximize motor performance.

The high torque of the embodiment described above results from slip between the squirrel cage rotors and the alternating magnetic field, but this slip limits the efficiency of the motor at operational speed. In order to achieve higher efficiency, the motor transitions to synchronous mode at a predetermined speed. The armature configuration is shown in FIG. 1b wherein the motor functions as a permanent magnet synchronous motor (PMSM). In this mode, the coaxially nested Halbach cylinders 101 and 102 rotating about the armature having field windings 107, 108, and 109 supply field poles.

At start up, or when high torque is required, the motor is configured to function as a typical induction motor. Although the magnet arrays produced a strong static magnetic field, this field is effectively short-circuited by the magnetic flux shield with it's flux bridges. The gap between the coaxial magnet arrays is thus free of interefering magnetic flux, and the energized stator will induce movement in the squirrel cage component of the hybride rotor.

At higher speeds, and where greater efficiency is required, the motor transitions to synchronous mode. A variety of mechanisms are possible for releasing the flux shield, but one way would be to employ a centrifugal release mechanism that has a weight that forces the release of the flux bridges at a predetermined RPM. Once the permanent magnet poles of the magnet arrays are exposed the motor can function the more efficient synchronous mode.

### CONCLUSIONS, RAMIFICATIONS, AND SCOPE

The embedded squirrel cage design allows for minimal gap between the armature and squirrel cages, and the presence of two squirrel cages rather than one contributes to motor performance. By design, the squirrel cage has spaces between the bars that are ideally suited for the alternating poles of the field magnet assembly. The Halbach cylinder provides the idea geometry for generating magnetic field poles as an individual cylinder, but can also be employed too much greater effect by the coaxial magnetic coupling of two Halbach cylinders. In a hybrid design, the fact that the squirrel cage bars fit between the magnet field poles makes the squirrel cage rotor a perfect fit for the Halbach cylinder.

Coaxially nested Halbach cylinders have, up until the present, been employed for mechanic means. The magnetic coupling between cylinders provided means where by the torque produced by one cylinder was transferred to the other. No examples could be found in the prior art wherein a flux shield was employed to block this flux for asynchronous operation.

The hybrid squirrel cage/Halbach cylinder rotor functions well within the various embodiments outlined above. This novel hybrid rotor, however, will function well within any motor with means to generate a rotating magnetic field for asynchronous operation, and means to generate a polyphase alternating magnetic field for synchronous operation.

Having thus described the present invention by reference to various embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A magnet array for a motor comprising:
a. a plurality of contiguous permanent magnets;
b. the magnets each having a magnetic polarity opposed to an adjacent magnet by about 90 degrees such that a reinforcing magnetic flux emanates substantially from one side of the array in a pattern of alternating polarity;
c. a magnetic shield attached releasably to the permanent magnets;
d. the magnetic shield comprising one or more flux bridges; and
i. the flux bridges comprise iron, silicon steel, or other ferromagnetic material;
ii. the flux bridges being disposed between adjacent magnetic poles so that said flux bridges complete a magnetic circuit between adjacent poles of the magnet array thereby substantially shielding the neighboring environment from magnetic flux;
whereby the magnetic shield may be released when magnetic flux from the magnet array is required and engaged when magnetic flux from the magnet array is not desirable.

2. The magnet array of claim 1 further comprising flux diffusers located at poles on the reinforcing side of the array.

3. A hybrid rotor for a motor comprising:
a. an induction rotor comprising elongated conducting rotor bars disposed substantially parallel to an axis, and further comprising conducting shorting segments attached so to create an electrical connection between neighboring rotor bars, wherein said induction rotor experiences substantial torque when exposed to a rotating magnetic field,
b. a magnet array comprising
i. a plurality of contiguous permanent magnets;
ii. the magnets each having a magnetic polarity opposed to an adjacent magnet by about 90 degrees such that a reinforcing magnetic flux emanates substantially from one side of the array in a pattern of alternating polarity;
c. a magnetic flux shield attached fixably to the induction rotor;
d. the magnetic flux shield attached releasably to the magnet array, such that when engaged the magnetic flux shield occupies a first position substantially shielding the induction rotor from magnetic flux produced by the magnet array and when released the magnetic flux shield occupies a second position substantially exposing magnetic flux from the magnet array;
whereby said hybrid rotor is suitable for employment in a synchronous or asynchronous motor.

4. The hybrid rotor of claim 3, wherein the magnetic flux shield further comprise flux diffusers attached to the magnet array on the reinforcing side of the array wherein said flux diffusers increase fringing so as to substantially smooth torque ripple.

5. The hybrid rotor of claim 3, wherein said rotor bars are not parallel to the axis but are skewed slightly along the length of the rotor bars so as to reduce noise and smooth out torque fluctuations.

6. The hybrid rotor of claim 3, wherein said conducting bars comprise:
a. a plurality of outer rotor bars disposed equidistant from said axis, and
b. a plurality of inner rotor bars disposed between the outer rotor bars and said axis such that the inner rotor bars are disposed each at the same predetermined distance from said axis.

7. The hybrid rotor of claim 3, wherein the inner rotor bars and the outer rotor bars are not parallel to the axis but are skewed slightly along the length of the rotor bars so as to reduce noise and smooth out torque fluctuations.

8. A motor comprising:
a. a stator comprising field windings;
b. one or more magnet arrays attached rotatably to the stator; and
c. a hybrid rotor disposed in the gap between the stator and the magnet array, and
d. the hybrid rotor comprising:
i. an induction rotor;
ii. a magnetic flux shield attached fixably to the induction rotor;
iii. the magnetic flux shield attached releasably to said one or more magnet arrays, such that when engaged the magnetic flux shield occupies a first position substantially shielding magnetic flux produced by the magnet array and when released the magnetic flux shield occupies a second position substantially exposing magnetic flux from the magnet array;
wherein the motor creates torque between stator and magnet array during synchronous operation, and the motor creates torque between the stator and the induction rotor during asynchronous operation.

9. The motor of claim 8, further comprising a centrifigal release mechanism attached to the magnetic flux shield.

10. The motor of claim 8, wherein said magnetic flux shield is attached slidably to said magnet array.

11. The motor of claim 8, wherein said magnetic flux shield is attached rotabably to said magnet array.

12. The motor of claim 8, wherein said stator is configured for single phase alternating current.

13. The motor of claim 8, wherein said stator is configured for two-phase alternating current.

14. The motor of claim 8, wherein said stator is configured for three-phase alternating current.

15. (canceled)

16. (canceled)

17. The motor of claim 8, wherein the magnet array comprises:
a. an outer cylinder comprising a plurality of contiguous permanent magnets, each magnet having a magnetic polarity opposed to an adjacent magnet by about 90 degrees so that circumferentially-oriented permanent magnets alternate with radially-oriented permanent magnets, whereby said outer cylinder is configured so as to direct magnetic flux substantially radially inward; and
b. an inner cylinder comprising a plurality of contiguous permanent magnets, each magnet having a magnetic polarity opposed to an adjacent magnet by about 90 degrees so that circumferentially-oriented permanent magnets alternate with radially-oriented permanent magnets, whereby said inner cylinder is configured so as to direct magnetic flux substantially radially outward;
wherein the inner cylinder and the outer cylinder are coaxial and magnetically coupled.

18. The motor of claim 17, wherein the induction rotor comprises:
a. elongated conducting rotor bars disposed substantially parallel to an axis, and
b. conducting shorting segments attached so to create an electrical connection between neighboring rotor bars,
c. a plurality of outer rotor bars disposed equidistant from said axis, and
d. a plurality of inner rotor bars disposed between the outer rotor bars and said axis such that the inner rotor bars are disposed each at the same predetermined distance from said axis,
e. a gap between said outer rotor bars and said inner rotor bars sufficient to allow relative rotation of the stator within said gap,
wherein said induction rotor experiences substantial torque when exposed to a rotating magnetic field.

19. The motor of claim 18, wherein the magnetic flux shield comprises:
a. an inner magnetic flux shield comprising a plurality of flux bridges disposed between the inner cylinder and the inner rotor bars of the induction rotor equal in number to the number of magnetic field poles generated by the inner cylinder, wherein said flux bridges substantially complete a magnetic circuit between neighboring magnetic poles thereby substantially shielding the induction rotor from magnetic flux generated by the inner cylinder during asynchronous motor operation, and
b. an outer magnetic flux shield comprising a plurality of flux bridges disposed between the outer cylinder and the outer rotor bars of the induction rotor equal in number to the number of magnetic field poles generated by the outer cylinder, wherein said flux bridges substantially complete magnetic circuits between neighboring magnetic poles thereby shielding the induction rotor from magnetic flux generated by the outer cylinder during asynchronous motor operation, and
c. A means for switching the magnetic flux shield between a first position and a second position, the first position magnetically shielding the induction rotor from the magnet array during asynchronous motor operation, and the second position allowing the flow of magnetic flux from the magnet array to the stator during synchronous motor operation,
d. a stator disposed between the inner rotor bars and the outer rotor bars of the induction rotor and attached rotatably to the magnetic flux shield.

20. The motor of claim 19 wherein said means for switching comprise a centrifugal release mechanism.

21. (canceled)

22. (canceled)

23. A machine suitable for producing mechanical torque comprising;
a. a stator comprising field windings;
b. a magnet array attached rotatably to the stator;
c. a hybrid rotor attached rotatably to the magnet array and disposed between the stator and the magnet array, and
d. the hybrid rotor comprising:
i. an induction rotor;
ii. a magnetic flux shield attached releasably to the magnet array and disposed between the magnet array and the induction rotor, thereby substantially shielding the magnet array when engaged, and when released substantially allowing release of magnetic flux from the magnet array,
wherein an electromotive force is produced by relative motion of the stator and magnet array during synchronous operation, and an electromotive force between the stator and the induction rotor during asynchronous operation.

24. A hybrid motor comprising:
a. a stator comprising field windings;
b. a hybrid rotor comprising:
i. an induction rotor;
ii. a magnet array;
iii. a magnetic flux shield; and
iv. the magnet array comprising a pair of coaxial double-nested Halbach cylinders, configured such that:
(1) the outer Halbach cylinder comprises a plurality of contiguous permanent magnets, each magnet having a magnetic polarity opposed to an adjacent magnet by a substantially orthogonal angle so that circumferentially-oriented permanent magnets alternate with radially-oriented permanent magnets, whereby said outer Halbach cylinder is configured so as to direct magnetic flux substantially radially inward; and
(2) the inner Halbach cylinder comprises a plurality of contiguous permanent magnets, each magnet having a magnetic polarity opposed to an adjacent magnet by a substantially orthogonal angle so that circumferentially-oriented permanent magnets alternate with radially-oriented permanent magnets, whereby said inner Halbach cylinder is configured so as to direct magnetic flux substantially radially outward; and
(3) the inner Halbach cylinder and the outer Halbach cylinder are coaxial and magnetically coupled;
v. the induction rotor comprising inner and outer rotor bars disposed such that:
(1) the outer rotor bars are disposed substantially parallel to an axis, equally spaced apart from one another, each distributed at the same predetermined distance from said axis, and
(2) each outer rotor bar is attached to an adjacent outer rotor bar at one end of each bar by a circumferentially oriented conducting segment, so that each outer rotor bar is attached to only one other outer rotor bar, and
(3) the inner rotor bars are disposed substantially parallel to said axis, equally spaced apart from one another, distributed at a predetermined distance from said axis that is lesser than the distance between said axis and an outer rotor bar, arranged so that each inner rotor bar lies between an outer rotor bar and said axis, and
(4) each inner rotor bar is attached to an adjacent inner rotor bar at one end of each bar by a circumferentially oriented conducting segment, so that each inner rotor bar is attached to only one other inner rotor bar, and
(5) each outer rotor bar is attached to the nearest inner rotor bar at one end of each bar by a radially oriented conducting segment connecting the two ends, so that each outer rotor bar is attached to only one inner rotor bar, and
wherein the outer rotor bars, the inner rotor bars, and the conducting segments are attached contiguously so as to complete a single closed electrical circuit,
vi. the magnetic flux shield being attached rotatably to the magnet array, comprises:
(1) an inner flux bridge assembly attached to a rotatable support frame disposed between the inner Halbach cylinder and the inner rotor bars of the induction rotor, comprising flux bridges equal in number to the number of magnetic field poles generated by the inner Halbach cylinder, wherein said flux bridges substantially complete a magnetic circuit between neighboring magnetic poles thereby shielding the induction rotor from the magnet array, and
(2) an outer flux bridge assembly attached to a rotatable support frame disposed between the outer Halbach cylinder and the outer rotor bars of the induction rotor, comprising flux bridges equal in number to the number of magnetic field poles generated by the inner Halbach cylinder, wherein said flux bridges substantially complete magnetic circuits between neighboring magnetic poles thereby shielding the induction rotor from the magnet array during asynchronous motor operation, and
(3) a servomotor for urging rotation of the magnetic flux shield so as to disrupt the magnetic circuits created by the flux bridges and expose the magnetic field poles of the magnet array during synchronous motor operation;
c. the stator being disposed between the inner rotor bars and the outer rotor bars of the induction rotor.
